(19) United States
(12) Patent Application Publication
(10) Pub. No.: US 2015/0298414 A1
(43) Pub. Date: Oct. 22, 2015

(54) METHOD FOR PRODUCING A FLANGED CAP, AND A FLANGED CAP

(71) Applicant: Datwyler Pharma Packaging International NV, Alken (BE)

(72) Inventors: Ralf DITTMER, Straubenhardt (DE); Ronny Prosper Elisabeth VRIJENS, Vliermaalroot (BE)

(73) Assignee: Datwyler Pharma Packaging International NV, Alken (BE)

(21) Appl. No.: 14/389,836

(22) PCT Filed: Mar. 21, 2013
(86) PCT No.: PCT/EP2013/055933

§ 371 Date: Oct. 1, 2014

(30) Foreign Application Priority Data
Apr. 3, 2012 (DE) 102012102881.8

(51) Int. Cl. B29D 99/00; A61J 1/14

(52) U.S. Cl. CPC B29D 99/0096; A61J 1/1412; B29K 2023/00

(57) ABSTRACT

A method produces a flanged cap and a flanged cap for a vessel accommodates a pharmaceutical substance, particularly a vial, wherein the flanged cap is formed from one material strip (M) having a film layer that has already been plastic-coated, wherein the material strip is thereafter stamped out and shaped via deep-drawing. A plastic component is affixed on the plastic coating of the flanged cap that forms a plastic layer. A flanged cap for a vessel for accommodating a pharmaceutical substance, particularly a vial, is formed from a metal film layer, wherein the film layer is likewise covered on the outside with a plastic layer that forms a coating on the film layer. A vessel contains a pharmaceutical substance.

The invention relates firstly to a method for producing a flanged cap for a vessel for receiving a pharmaceutical substance, in particular a vial, the flanged cap being formed by a strip of material having a foil layer which has already been coated with plastics material and said material strip then being stamped out and shaped by deep drawing.

The invention also relates to a flanged cap for a vessel for receiving a pharmaceutical substance, in particular a vial, which is covered by a metallic foil layer and is covered in any case on the outside by a plastics layer which forms a covering of the foil layer.

Furthermore, the invention also relates to a vessel containing a pharmaceutical substance, in particular to a vessel in the form of a vial, said vessel being closed by a flanged cap and said flanged cap having a metallic foil layer which is covered in any case on the outside by a plastics layer which forms a covering of the foil layer.

Flanged caps as such of this type, without the already coated foil layer, are already known in various respects. Reference is made, for example, to EP 291 658 A1, EP 663 347 A2 and to EP 598 179 A1. It is already known from the mentioned EP 663 347 A2 to form an aluminium flanged cap with an inner cap formed from a plastics film portion. Reference is also made to this document with regard to the production of a flanged cap in general by a stamping/bending forming procedure. Furthermore, reference should also be made to U.S. Pat. No. 5,794,804 A1. It is known from this document to form an aluminium metal foil layer into a cap shape and then to coat said foil layer with a polymeric material to avoid particles.

The non-prior-published WO application PCT/EP 2011/067734 describes the production of a flanged cap from a strip of material having a foil layer already coated with plastics material, which strip of material is then stamped out and shaped by deep drawing.

Reference is also made to the above-mentioned prior art with regard to the flanged cap for a vessel as the subject matter.

Proceeding from the mentioned prior art, the object addressed by the invention in terms of method is to provide an advantageous method for producing a flanged cap. The object in terms of subject matter is to provide an advantageous flanged cap and furthermore to provide a vessel which is advantageously closed by a flanged cap.

According to a first inventive concept, a possible achievement of the object is provided by a method which focuses on the fact that a plastics part is attached to the plastics coating of the flanged cap which forms a plastics layer. According to the invention, it has been found that the plastics layer, present anyway, can be used due to the use of a plastics material-laminated metal foil starting material, to advantageously join a plastics part, for example a plastics cover part and/or a plastics lower part and/or a plastics overcap to the flanged cap. According to the method described in the mentioned WO application, a strip of material which has, as a starting material, a metallic foil layer already coated with plastics material, is shaped into the flanged cap by stamping out and deep drawing, a plastics part also being attached to the strip of material.

The plastics cover part is preferably a plastics part which is attached to the outside of the flanged cap, more preferably to the top, but also additionally or only to a cap wall of the flanged cap. The plastics lower part is a plastics part which is attached to the flanged cap, preferably inside the flanged cap, for example on the inside of the top and/or on the inside of the peripheral region. The plastics overcap is a part which is arranged such that it engages over the flanged cap from outside and at least in part extends in the top region and in the region of the cap wall of the flanged cap.

With regard to achieving the object in terms of the subject matter, a flanged cap is proposed which is distinguished by a metallic foil layer and in any case on the outside of the foil layer is distinguished by a plastics layer forming a covering of the foil layer, the flanged cap furthermore being joined to a plastics part, for example at the top and/or at the wall of the cap, furthermore for example on the outside or inside. The plastics part is preferably a plastics part produced by injection moulding. The join is achieved by means of the plastics layer forming the covering of the foil layer. The plastics part can also be a hard plastics part or a soft plastics part. In this respect, it can consist, for example, of polypropylene (PP) or polyethylene (PE) or of a thermoplastic elastomer (TPE).

The object is also achieved in terms of the subject matter by a vessel which is closed by a flanged cap, whereby the flanged cap has a metallic foil layer which is covered in any case on the outside by a plastics layer forming a covering of the foil layer and the flanged cap is bonded to a plastics part in the manner already described above.

Further features of the invention are described below, and also in the description of the figures and in the drawings, in each case both in respect of the method and of the mentioned subjects, often preferably associated with the concept described above. However, they can also be significant in association with one or more individual features which are described or illustrated here, or independently and/or in a different overall concept. The flanged cap can be produced, for example, by stamping out a foil layer already coated in plastics material and by subsequently deep drawing the stamped part. After the flanged cap has been formed as described, the plastics part can then be attached thereto. However, it can also be attached to the strip of material before the stamping-out procedure or before the shaping procedure. In the latter case, the plastics part is, for example, also stamped through during the stamping-out procedure or is (only) provided in a size such that it is within a stamping contour. When the plastics part is applied to the stamped-out strip of material, it is inserted in any case into the shaping tool together with the strip of material, preferably already finally joined with the material strip and shaped together with the material strip into the flanged cap. This is particularly advisable when the plastics part is (only) provided outside regions which are subject to a significant shaping, for example in the top region of the flanged cap.

With regard to the production method, the production method achieved is, on the one hand, very efficient. It is possible to use commercially available strips of material which have a metallic foil layer, for example a layer of aluminium, with a corresponding covering, even if they have not been used hitherto for this purpose. It has also been found that with regard to the particular demands made on a flanged cap for a vessel containing pharmaceutical substances, such as in particular a vial filled, for example, with medicinal powder or medicinal liquid, the risk of the detachment of particles which can otherwise happen when handling a flanged cap is very significantly reduced. The mentioned detachment risk exists in practically all handling stations, thus particularly during production, transportation, washing, sterilising and/or when attaching the flanged cap to an appropriate vessel.

Bonding with a plastics part makes it possible to firstly stabilise specific regions of the flanged cap, for example. However, alternatively or additionally, this bonding makes it possible to achieve a tamper-evident seal. On the one hand, the plastics part can be provided such that it can break or tear off, preferably in a region which is not, or is only in part, joined to the flanged cap. This is particularly and preferably the case when the plastics material is configured as an overcap. On the other hand, the tamper-evident seal can also be achieved in a region in which the plastics part is bonded in a planar manner to the flanged cap, while providing the plastics lamination of the metal foil. The bonding, particularly in a case of this type, is preferably performed such that the plastics part can only be removed from the flanged cap together with the foil layer. Thus, the foil layer tears or tears off when an attempt is made to remove the plastics part, for example to release an insertion opening.

A disruptive effect on the plastics part and/or on the flanged cap can then also be immediately detected visually. This is particularly obvious and is therefore preferred, if the plastics layer has a distinctly different colour than the foil layer which is then visible at the tear-off point or points. Furthermore or alternatively, if the plastics part is attached to the inside of the flanged cap for example, it is also possible for the vial opening to be protected during flanging and/or for a stopper plug covering the flanged cap to be specifically acted on, for example on the edge thereof, to increase the contact pressure.

It is also preferred that the top of the cap has a preferably central passage opening in a manner known per se. In this respect, it is also preferred that the plastics part is (only) bonded with a lateral spacing and, when the opening is round, having a radial spacing, from a peripheral edge of the opening. A closed peripheral region which comprises the peripheral edge of the opening thereby preferably remains unbonded to the plastics part. The region in which there is no bonding with the plastics part around the peripheral edge of the opening can correspond to a 1/10 to 1/1 measurement from the centre to the peripheral edge of the opening, for example based on a radial to a centre of the opening.

The features described in the following can be significant both for the method subject matter of the application and for the device subjects of the application, i.e. for the flanged cap and the vessel closed by the flanged cap.

As already mentioned in principle, it is preferred that the stamping out and deep-drawing procedures are carried out in a single combined step.

Furthermore, it is preferred that the stamping tool is configured with production in mind such that a tensile extension of the plastics layer which results in the plastics layer projecting over the stamped edge of the foil layer is produced on the stamped edge. In this respect, it has been found that this tensile extension of the plastics layer which is present can be achieved by a relatively blunt setting of the tool. The sharpness of the stamping tool which is only actually necessary to achieve this effect can be determined empirically. It can also vary subject to the actual configuration of the foil layer or of the plastics layer and optionally also of the plastics part bonded thereto.

After the stamping out and deep-drawing procedures of the stamped-out foil portion into the flanged cap, which procedures, as described, are preferably carried out simultaneously, a cap part is produced which is U-shaped in cross section and the edge of which has either a peripheral edge with the plastics layer and foil layer separated at practically the same level or has a peripheral edge with a plastics layer which is lengthened and engages externally over the foil layer. The lengthening here can be relatively short. It is preferably calculated in the order of the thickness of the metallic foil layer. This thickness can be, for example, 0.05-0.5 mm.

Pulling the plastics layer beyond the mentioned edge of the foil layer produces a stretching of the plastics layer associated with the mentioned peripheral region. Thereafter, in a further step, this thus stretched region of the plastics layer can be bent around the cut edge of the foil layer and bonded therewith or, for example, moved therewith.

The last-mentioned procedure produces a flanged cap in which the stretched plastics material covers the cut edge of the foil layer. The stretching is produced in a region remote from the peripheral edge in comparison with the plastics layer. Here, a remote region is a region which is at a distance of 1 mm or more, for example up to 5 mm, from the peripheral edge.

Furthermore, a lacquer coating can be applied between the plastics layer and the metallic foil layer, in particular to give the flanged cap a desired colouring, pattern or the like. In such a case, the plastics layer is in any case preferably transparent or only lightly coloured. The coloured appearance can then be substantially determined by the lacquering. The lacquer coating is preferably an epoxy resin-based lacquer. The lacquer coating can have a thickness of, for example, 2-5 μm.

It can also be provided that the plastics layer is transparent and is joined to the metallic foil layer by an adhesive which produces a colour effect and is visible through the plastics layer. In this configuration, a desired colour effect can be achieved just by using an adhesive coloured in this respect. The lacquer coating can then be omitted. It is then merely necessary to apply a transparent plastics film, for example, as the plastics layer. This configuration is preferably realised on the upper side or on the outer face of the flanged cap. However, it can also be realised on the underside or on the inner face.

The mentioned plastics layer can have the same thickness as the metallic foil layer, but it can also be thinner or thicker, for example up to a strip width of 0.03-3 times the thickness of the metallic foil layer or up to 0.8 mm thick.

The plastics layer can also be provided on both sides of the foil layer.

The plastics layer can be a conventional PP or PE film, for example, which is applied beforehand to the metallic foil layer, in particular is bonded with the metallic foil layer, an adhesive layer being inserted therebetween. The plastics layer can also consist, for example, of polyethyleneterephthalate (PET) or of polyurethane (PU).

The metallic foil layer is preferably an aluminium foil layer.

The plastics part can be firstly bonded with the material strip or with the flanged cap by adhesion, i.e. by applying a separate adhesive layer to the appropriate side of the plastics part and/or of the material strip or flanged cap. However, it is preferred that the bonding is realised by welding. For this purpose, the surface of the material strip, i.e. the plastics film layer, and/or the corresponding side of the plastics part can be heated by infrared radiation so that softening occurs up to the required welding temperature and the parts are then welded by being pressed together. Here, it is obviously advantageous, as preferably also provided, that both plastics materials are thermoplastics.

However, it is further preferred that the welding is carried out using ultrasound. This is also inside a thinned-down region of the plastics part. In ultrasonic welding, it can also be advantageously achieved at the same time that stamping oil which may be used during production of the flanged cap is displaced from the welding region by vibrations from the ultrasound and consequently a washing procedure which might otherwise be necessary can be avoided.

It is also preferred that the flanged cap is joined to the plastics part only by the mentioned bonding, by adhesion or welding. It is possible to fully dispense with a positive join which is otherwise provided in such cases.

A further option for joining the plastics part to the flanged cap is to overmould the flanged cap after production or to (already) overmould the material strip in the injection moulding process and in the latter case to then allow the plastics part, thus bonded with the material strip in the injection moulding process, to pass through the stamping tool and the shaping tool in the state joined with the material strip.

The ranges or value ranges or multiple ranges stated above and below also include, in respect of the disclosure, all intermediate values, particularly in one tenth steps of the respective dimension, optionally thus also without dimensions, for example 1/10 μm, 0.1 times etc., on the one hand to limit the mentioned range boundaries from below and/or above, but alternatively or additionally also in respect of the disclosure of one or more singular values from the respectively stated range.

In the following, the invention will be described with reference to the accompanying drawings which, however, show only one embodiment, in which:

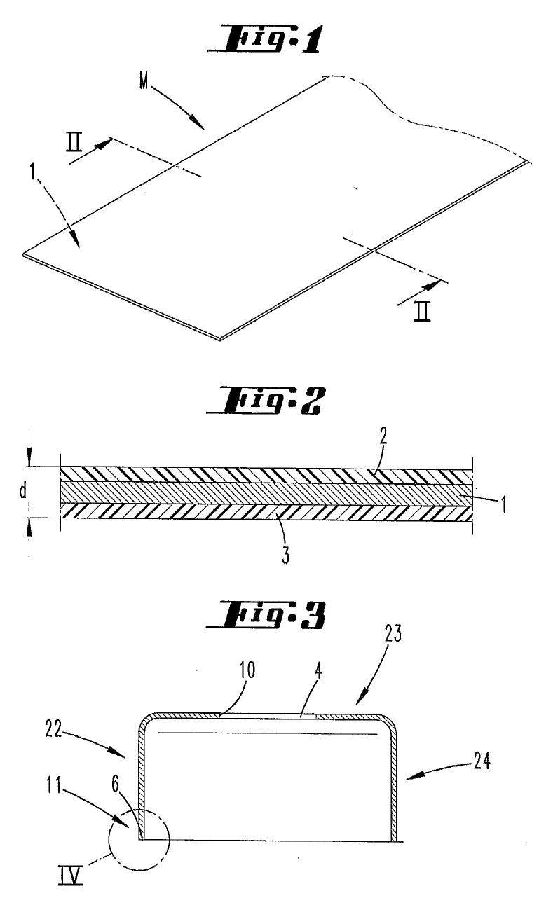

FIG. 1 shows a portion of a coated metallic foil layer;

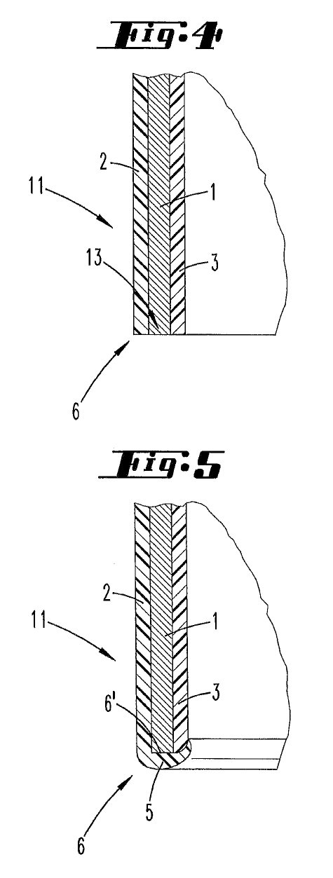

FIG. 2 shows a cross section through the subject matter according to FIG. 1, along the line II-II;

FIG. 3 shows a coated metallic foil layer shaped into a flanged cap;

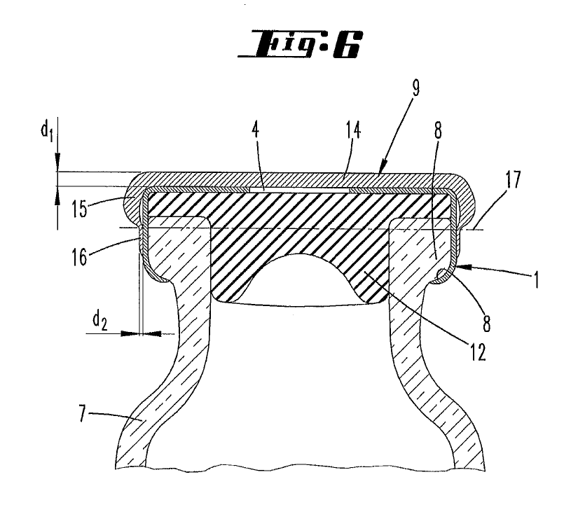

FIG. 4 shows an enlarged detail from FIG. 3;

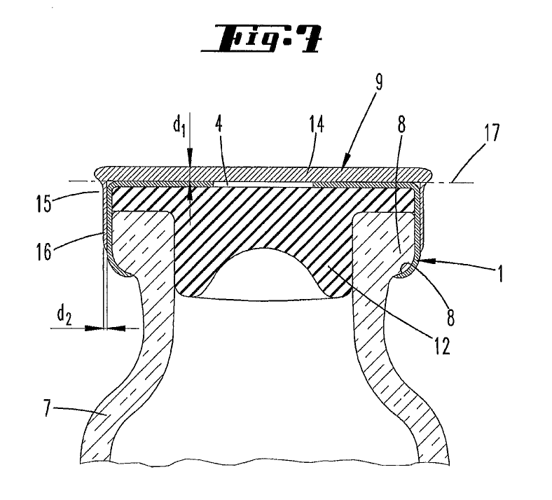

FIG. 5 shows a further enlarged detail of a subject matter according to FIG. 3 in an alternative embodiment;

FIG. 6 is a cross-sectional view of a flanged cap joined to a plastics part in the form of an overcap, applied to a vial;

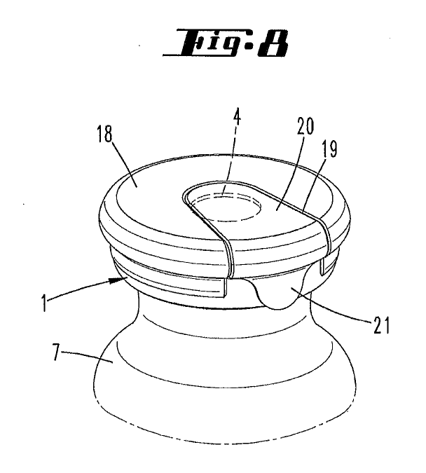

FIG. 7 shows an embodiment in the manner of FIG. 6, but in which a tear line is arranged in the region of the top of the cap; and

FIG. 8 is a perspective view of a further flanged cap provided with a plastics part and attached to a vial.

A material strip M is shown and described first of all, which strip has a metallic foil layer 1 which is coated on the upper and lower sides with a plastics layer 2, 3 (see also FIG. 2). The coating is provided by an extruded plastics layer 2, 3 (plastics film) which is preferably joined to the metallic foil layer 1 by an adhesive layer (not shown). Alternatively, it can also be, for example, a blow-moulded film or a film which is directly extruded onto the metallic foil layer. According to FIG. 3, the material strip M is shaped into a flanged cap 22 in a combined stamping-out and shaping procedure which is not shown in detail. The flanged cap 22 has a cap top 23 and a cap wall 24 which extends downwards during use, preferably at a right angle to the cap top 23. Preferably punched into the centre of the top 23 of the cap is an opening 4 which can be covered by an overcap 9 when finally applied to a vial 7, as shown for example in FIG. 6. In the embodiment, the metallic foil layer 1 is an aluminium foil layer.

FIGS. 4 and 5 show different configurations of the peripheral edge 6 of the wall 24 of the flanged cap 22 according to FIG. 3. The same configuration can also be provided in respect of the peripheral edge 10 of the opening 4. To achieve the excess length of the plastics layer 2 on the peripheral edge 10 of the opening, it can also be advisable to bend the respective peripheral region of the flanged cap 22 downwards, in an approximately parallel orientation to the peripheral edge 6. In this case, a length of the downwardly bent region can be relatively short, for example 0.5-10 times the overall thickness d of the foil layer 1.

The information concerning the stretching of the plastics layer 2 and 3 also applies similarly in respect of the peripheral edge 10 of the opening.

The mentioned overall thickness d of the foil layer 1 with the plastics layer 2 and/or 3 can be, for example, 50-1000 μm.

FIG. 4 shows a cut edge 13 in which the two plastics layers 2, 3 as well as the foil layer 1 have a cut edge 13, which runs at a right angle to the vertical extent of the flanged cap edge 11, shown enlarged here, at approximately the same height. In FIG. 5, the outer plastics layer 2 is lengthened by stretching during the stamping procedure such that an overlapping portion 5 is produced which is passed around the end face 6′ of the foil layer 1 and, in the embodiment, is joined, for example by adhesion or by welding, to the inner plastics layer 3. A complete covering of the end face 6′ of the metallic foil layer 1 is thus also achieved.

In the embodiment in FIG. 6, the flanged cap 22 is applied to the upper region of a vial 7. Inserted into the opening of the vial 7 is a sealing plug 12 which is encompassed at the top and on the flange side by the flanged cap 22. As can be seen, the flanged cap 22 is bent round further (flanged) into the under-grip to a vial opening edge 8. While the flanged cap 22 is being applied to the vial 7, the respective lower flanged cap edge 11 can be pressed onto the vial 7 by a presser tool to rest against the vial 7 in the illustrated under-grip to the vial opening edge 8.

Furthermore, applied from above to the flanged cap 22 is a plastics overcap 9 which is in part, namely in region 16, bonded to the flanged cap 22.

It can be seen that the overcap 9 also has a U-shaped form in cross section. In detail, it has an overcap top 14 and an overcap wall 15. The overcap 9 consists of a hard plastics material.

In the region of its top 14, the overcap 9 can have a thickness d₁ which is the same as or is greater than the thickness of the flanged cap 22. The thickness d₁ can correspond to, for example, five or ten times the thickness of the flanged cap 22, i.e. to the thickness of the laminated metal foil layer.

Furthermore, the overcap 9 has on its wall 15 a region 16 of a reduced thickness. Said region of reduced thickness can have, for example, a thickness d₂ which corresponds to one tenth to three-quarters of thickness d₁. The overcap 9 is preferably bonded with the flanged cap 22 in region 16, and more preferably is bonded with the flanged cap 22 only in region 16.

Furthermore, in this case the bonding is only made with the outer plastics layer 2, preferably by welding, more preferably by ultrasonic welding.

Accordingly, the flanged cap 22 is not bonded with the plastics part 18, here specifically to the overcap 9, in the remaining region, i.e. in the embodiment, above region 16. Said flanged cap can be removed, for example, by separating along a tear line 17, preferably configured here in the transition of region 16 to the remaining overcap, also for example by twisting according to a screw seal, for example.

The flanged cap 22 also has in a conventional manner the already mentioned top opening 4. Said opening 4 is covered by the overcap 9 according to the state in FIG. 6. After removing the break-off part of the overcap 9, the opening 4 for insertion into the sealing plug is exposed.

FIG. 7 shows a variant of the embodiment of FIG. 6, here the tear line 17 being arranged in the region of the plane of the top of the cap. After detachment, the top of the overcap thus forms a practically disc-shaped part and, with respect to the flanged cap, practically only the top of the cap is exposed after uncovering.

In the embodiment in FIG. 8, the plastics part 18 which is also applied here on the top of the flanged cap 22, is provided with a tear line 19 which produces a tongue-like region 20 which forms a tear-off tab 21 extending in the region of the cap wall 24 and in the region of the cap top 23. Tearing off the tear-off tab 21 can remove the region 20 of the plastics part 18. Here again, the region 20, as well as the remaining part of the plastics part or a part of the remaining plastics part can be bonded with the plastics film layer of the flanged cap. During tearing in this case, the plastics film layer can also be torn off so that this also makes it obvious that tampering has occurred after tearing off. At the same time, tearing off the tear-off tab 21 in this case also exposes the opening 4.

Instead of a partial removal of the plastics part 18, it is also possible to provide a configuration in which the plastics part 18 can be completely removed. This can be achieved, for example in that the welding region is very small so that when the plastics part is pulled off, the plastics layer welded in this respect is removed in this region.

All the disclosed features are essential (per se) to the invention. Also fully included hereby in the disclosure of the application is the disclosure content of the related/accompanying priority documents (copy of the prior application), also for the purpose of introducing features of these documents into claims of the present application. The dependent claims characterise, in their optionally independent versions, independent inventive developments of the prior art, particularly in order to make divisional applications on the basis of these claims.

### LIST OF REFERENCE SIGNS

1 foil layer
2 plastics layer
3 plastics layer
4 opening
5 over-grip portion
6 peripheral edge of flanged cap
6′ end face
7 vial
8 opening edge of vial
9 overcap
10 peripheral edge of opening
11 edge of flanged cap
12 sealing plug
13 cut edge
14 top of overcap
15 wall of overcap
16 region
17 tear line
18 plastics part
19 tear line
20 region
21 tear-off tab
22 flanged cap
23 top of cap
24 wall of cap
d overall thickness
d₁ thickness
d₂ thickness
M strip of material

1-11. (canceled)

12: A method for producing a flanged cap (22) for a vessel for receiving a pharmaceutical substance, in particular a vial (7), the flanged cap (22) being formed by a material strip (M) having a foil layer which has already been coated with plastics material and said material strip then being stamped out and shaped by deep-drawing, a plastics part (18) further being attached to the plastics coating of the flanged cap which forms a plastics layer, wherein the flanged cap (22) has a top (23) and a cap wall projecting downwards from the cap top (23), and wherein the plastics part is bonded with the cap wall.

13: The method according to claim 12, wherein a weakening defining a tear-off line is formed on the plastics part bonded or to be bonded on the outer side of the cap top (23).

14: The method according to claim 12, wherein the plastics part (18) is bonded with an outer side and/or an inner side of the flanged cap (22).

15: The method according to claim 12, wherein the plastics part has a greater thickness than the plastics coating.

16: The method according to claim 12, wherein the plastics part is a flat part which has at least an area corresponding to a third or more of the surface area of a flanged cap top (23).

17: The method according to claim 12, wherein the plastics part is welded to the plastics coating.

18: The method according to claim 12, wherein the plastics part is a hard plastics part.

19: The method according to claim 12, wherein the plastics part is a soft plastics part.

20: The method according claim 12, wherein the cap top (23) has a preferably central passage opening and wherein the plastics part (18) is configured and/or is bonded with the flanged cap such that a lateral region remains recessed with respect to a peripheral edge of the opening.

21: The method according to claim 12, wherein the stamping tool is configured such that a tensile extension of the plastics layer, which projects over the stamped edge of the foil layer, is produced on the stamped edge.

22: A flanged cap for a vessel (7) for receiving a pharmaceutical substance, in particular a vial (7), which flanged cap is formed from a metallic foil layer (1), which foil layer (1) is covered in any case on the outside by a plastics layer (2, 3) forming a covering of the foil layer, the flanged cap (22) having a cap top (23) and a cap wall (24) extending at an angle from the cap top (23), wherein the flanged cap (22) is bonded at its cap wall (24) on the outside and/or on the inside with a plastics part.

23: The flanged cap according to claim 22, wherein the plastics part (18) is a hard plastics part or a soft plastics part.

24: The flanged cap according to claim 22, wherein the flanged cap has a flanged cap peripheral edge (6), and wherein the flanged cap peripheral edge (6) has a cut edge (13) which passes through both the foil layer (1) and the plastics layer (2, 3).

25: The flanged cap according to claim 24, wherein the flanged cap peripheral edge (6) is covered by a portion of the plastics layer (2, 3), which is stretched compared to the rest of the plastics layer.

26: A flanged cap for a vessel (7) for receiving a pharmaceutical substance, in particular a vial (7), formed from a metallic foil layer (1), which metallic foil layer (1) is covered in any case on the outside by a plastics layer (2, 3) forming a covering of the foil layer, wherein the plastics layer (2, 3) is transparent and is joined to the metallic foil layer (1) by an adhesive which is visible through the plastics layer (2, 3) and produces a colored effect.
